(19) United States
(12) Patent Application Publication
(10) Pub. No.: US 2012/0293332 A1
(43) Pub. Date: Nov. 22, 2012

(54) TEMPERATURE MONITORING BEVERAGE CONTAINER

(75) Inventor: Abraham Rosenfeld, Los Angeles, CA (US)

(73) Assignee: VENDETTA VENDING SOLUTIONS, LLC, Los Angeles, CA (US)

(21) Appl. No.: 13/112,213

(22) Filed: May 20, 2011

(51) Int. Cl. G08B 17/00; B65D 85/00

(52) U.S. Cl. 340/584; 206/459.1

(57) ABSTRACT

Temperature monitoring beverage containers and associated methods are provided. The containers include a temperature sensor operative to sense the temperature of a beverage stored within the container. The temperature of the beverage may be displayed on a display. The containers are also operative to provide one or more alerts to a user indicating that the beverage stored in the container may not be suitable for consumption. When used for beverages that are normally consumed when hot, the alerts may indicate to a user that the beverage is dangerously hot or undesirably cool. When used for beverages that are normally consumed when cold, the alerts may indicate to a user that the beverage is at a temperature known to cause spoilage of the beverage, thus preventing the user from consuming a potentially spoiled beverage. The alerts may be provided by way of an audible or visual indicator, such as an LED.

### FIELD OF THE INVENTION

The present invention relates to beverage containers. More specifically, the present invention relates to methods and devices for monitoring the temperature of beverages disposed within beverage containers.

### BACKGROUND OF THE INVENTION

All publications herein are incorporated by reference to the same extent as if each individual publication or patent application was specifically and individually indicated to be incorporated by reference. The following description includes information that may be useful in understanding the present invention. It is not an admission that any of the information provided herein is prior art or relevant to the presently claimed invention, or that any publication specifically or implicitly referenced is prior art.

There are a variety of types and sizes of containers used for storing a beverage. Some containers may be used for individual use, such as teacups, travel mugs, water bottles, and the like. Other containers may be configured to store a larger amount of a beverage. Examples of these types of containers are carafes, coffee or tea urns (or airpots), and insulated beverage containers such as a THERMOS (available from Thermos, LLC). Beverage containers may often include a lid that allows a user to add or remove the beverage from the container. One type of lid is a solid unitary lid that does not include any openings or apertures through which the contents of the beverage container may exit the container. Another type of lid includes one or more unobstructed apertures through which the contents may exit the container. Yet another type of lid includes one or more apertures through which the contents may exit the container and means for selectively opening and closing the apertures. This last type of lid allows a user to selectively open the aperture to removed its contents (e.g., by drinking or pouring) from the beverage container, and to selectively close the aperture to maintain the contents inside the container and potentially insulate the contents from the environment outside the container.

Beverages may be consumed and enjoyed by users at a variety of temperatures, often depending on the type of a particular beverage. For example, coffee may be enjoyed at temperatures within a range of, for example, approximately 110 degrees to 185 degrees. If the temperature of coffee is outside of this range, it may be dangerously hot or undesirably cool. As another example, milk or other dairy products may be prone to spoilage if they are maintained above certain temperatures (e.g., above 40 degrees). To prevent consumers of a beverage from drinking a beverage that may be spoiled or may cause illness if consumed, it would be beneficial to notify potential users that a particular beverage may not be suitable for consumption.

### BRIEF DESCRIPTION OF THE FIGURES

Exemplary embodiments are illustrated in referenced figures. It is intended that the embodiments and figures disclosed herein are to be considered illustrative rather than restrictive.

FIG. 1A depicts a temperature monitoring beverage container and lid assembly, in accordance with an embodiment of the present invention, when the lid is coupled to the beverage container.

FIG. 1B depicts the temperature monitoring beverage container and lid assembly of FIG. 1A when the lid is removed from the beverage container.

FIG. 2A depicts a left side, partial cross-sectional view of the lid of FIG. 1A, when an actuating member of the lid is in a non-activated position.

FIG. 2B depicts a left side, partial cross-sectional view of the lid of FIG. 1A when a user is depressing the actuating member of the lid.

FIG. 3A depicts a perspective view of the lid of FIG. 1A.

FIG. 3B depicts a perspective view of the lid of FIG. 1A when an electronics module is selectively removed from the remainder of the lid.

FIG. 4 depicts a block diagram of the lid of FIG. 1A.

FIG. 5 depicts a process for monitoring the temperature of a beverage in accordance with an embodiment of the present invention.

FIG. 6 depicts another process for monitoring the temperature of a beverage in accordance with an embodiment of the present invention.

FIG. 7 depicts another embodiment of a temperature monitoring beverage container, in accordance with an embodiment of the present invention, wherein the beverage container is in the form of an airpot.

FIG. 8 depicts another embodiment of a temperature monitoring beverage container, in accordance with an embodiment of the present invention, wherein the beverage container is in the form of an insulated beverage container.

FIG. 9 depicts another embodiment of a temperature monitoring beverage container, in accordance with an embodiment of the present invention, wherein the beverage container is in the form of a travel mug.

FIG. 10 depicts another embodiment of a temperature monitoring beverage container and lid assembly, in accordance with an embodiment of the present invention, wherein the lid includes an opening that is selectively openable and closable by rotating the lid relative to the beverage container.

FIG. 11 depicts a system for remotely monitoring the temperature of beverages inside a plurality of temperature monitoring beverage containers, in accordance with an embodiment of the present invention.

### DETAILED DESCRIPTION OF THE INVENTION

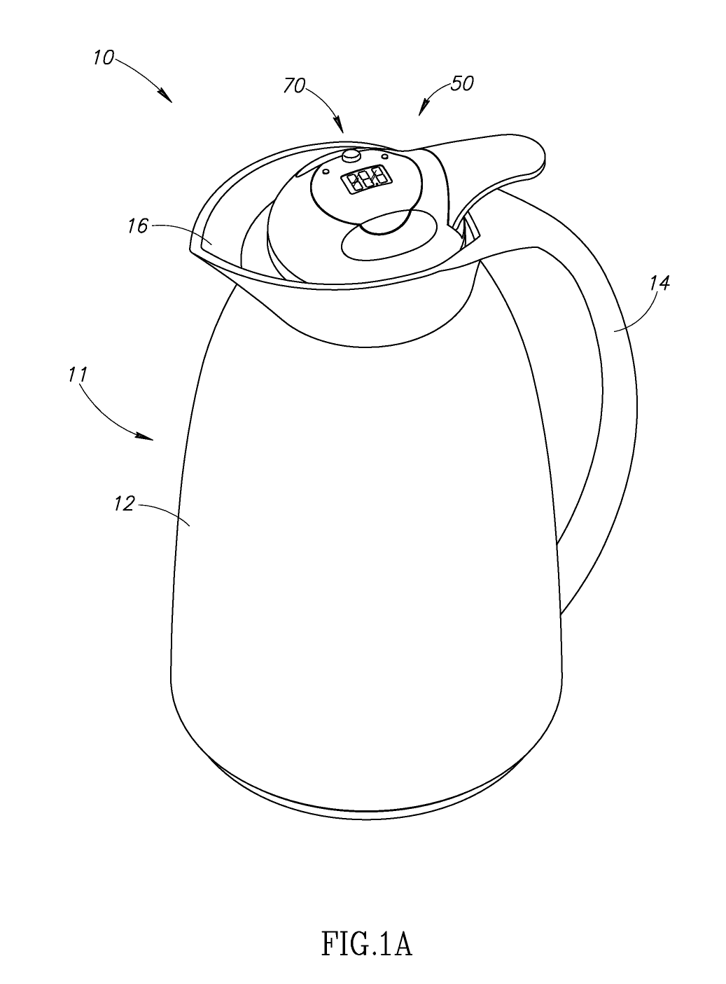

Referring now to the drawings in which like parts are designated by like reference characters throughout the several views, FIGS. 1-3 illustrate various views of a temperature monitoring beverage container and lid assembly 10 in accordance with an embodiment of the present invention. The assembly 10 comprises a beverage container 11 and a selectively removable beverage container lid 50. In this embodiment, the assembly 10 takes the form of a beverage container generally referred to as a “carafe.” The assembly 10 may be used to store beverages such as coffee, tea, milk, and the like.

The beverage container 11 includes a main body 12, a handle 14, and a mouth 16 having a pour spout. As shown in FIG. 1B, the top portion of the beverage container 11 includes an opening 18 disposed between an interior cavity of the main body 12 and the environment. The opening 18 includes interior threads 20 configured to threadably engage with corresponding exterior threads 87 of the lid 50 so that the lid may be selectively attached to the beverage container 11 to cover the opening.

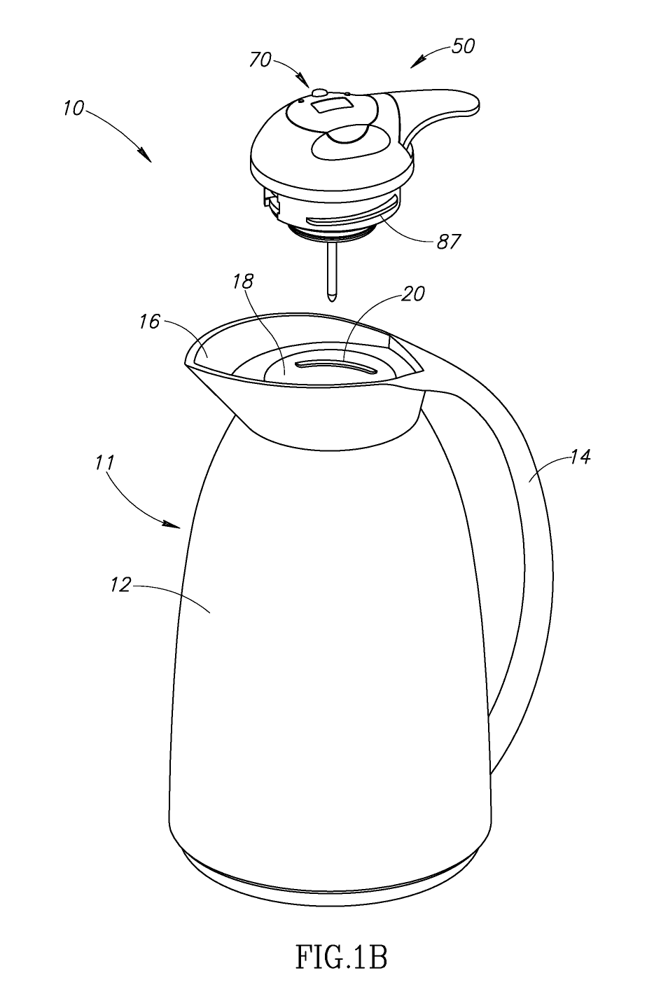

As may best be viewed in FIGS. 2A-B and 3A-B, the lid 50 comprises an upper body portion 82 and a lower body portion 86. As discussed above, the lower body portion 86 includes the exterior threads 87 configured to engage with the interior threads 20 of the beverage container 11. The lower body portion 86 is substantially hollow, forming an interior cavity 92 (see FIGS. 2A and 2B). The cavity 92 includes an opening 90 disposed on a front side (toward the left in the views of FIGS. 2A and B) of the lower body portion 86 of the lid 50. The cavity 92 also includes a downward facing opening 91 that is selectively sealable by a movable stopper 88.

The upper body portion 82 of the lid 50 comprises a left grip surface 84A and a right grip surface 84B. The grip surfaces 84A and 84B allow the user to grasp the lid 50 and rotate it relative to the beverage container 11 to selectively attach the lid to the beverage container. The upper body portion 82 also includes removable electronics module 100, which is discussed below. The upper body portion 82 further includes an actuating member 94 or “thumb trigger.” As shown in FIGS. 2A and 2B, the actuating member 94 may be selectively activated by a thumb 101 of the user. The actuating member 94 is operatively coupled to the stopper 88 so that the stopper is movable from a closed position wherein it covers the opening 91, to an open position wherein it is spaced apart from the opening 91 when the actuating member is depressed by the user. As indicated by the arrows 104 and 108 in FIG. 2B, a beverage may flow into the cavity 92 and out of the opening 90 when the stopper 88 is in the opened position and spaced apart from the lower body portion 86. Thus, by operating the actuating member 94, the user may selectively seal (FIG. 2A) and open (FIG. 2B) the beverage container 11.

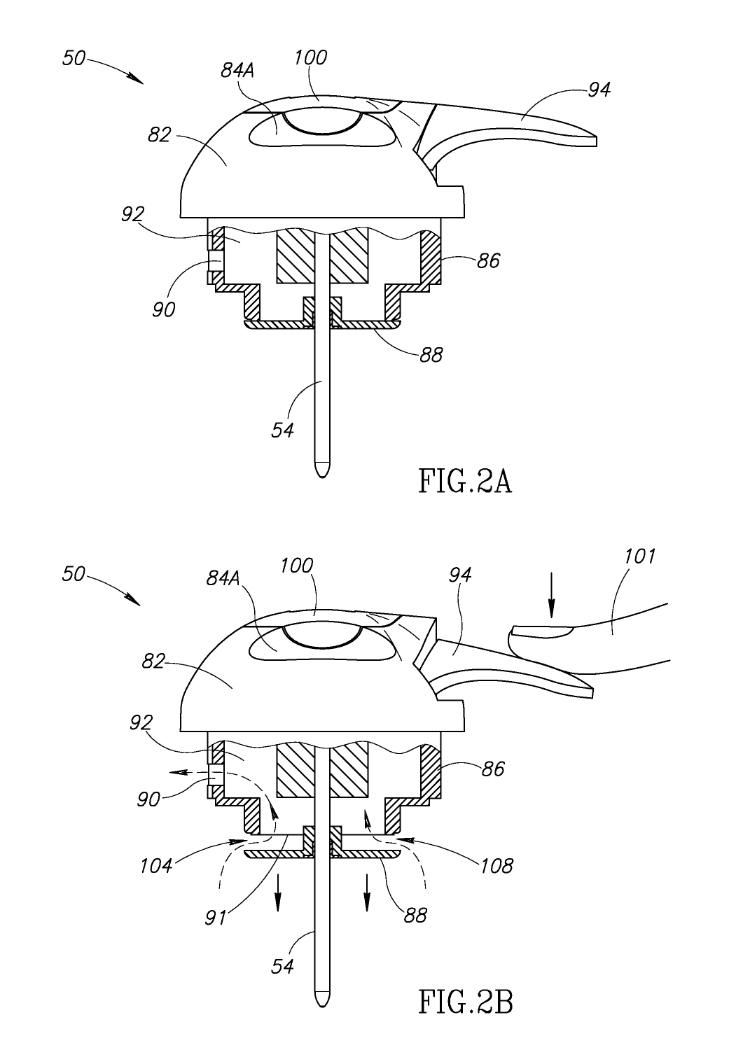

The electronics module 100 is selectively positionable within an upward facing cavity 110 of the upper body portion 82 of the lid 50. The electronics module 100 includes exterior threads 107 configured to engage with corresponding interior threads 112 disposed on an inner surface of the cavity 110. In operation, the user may selectively remove the electronics module 100 from the lid 50 (e.g., to replace a battery of the electronics module). As shown in FIG. 3B, the electronics module 100 is also operatively attached to a temperature sensor or probe 54 via a cable 114. The temperature probe 54 extends downward from the bottom of the lid 50 into the beverage container 11 when the lid 50 is coupled to the beverage container. The temperature probe 54 may be formed from any suitable material, in any suitable configuration and in any suitable length. In one embodiment, the temperature probe 54 is formed from a sealed stainless steel tube in a substantially cylindrical configuration that reaches a location near the bottom of the beverage container 11.

In an alternate embodiment (not shown), the electronics module 100 and cable 114 are housed in the main body of the beverage container 11, rather than in the lid 50. In such embodiments, the temperature probe 54 may be positioned in any desirable location in the main body of the beverage container 11.

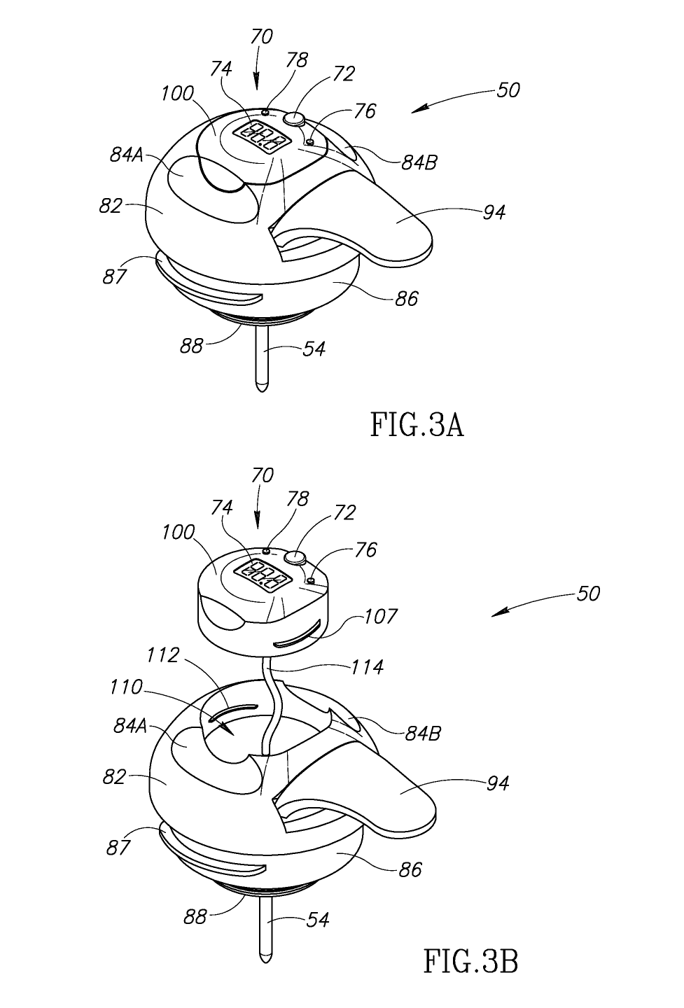

As may best be viewed in FIGS. 3A and 4, the electronics module comprises a user interface 70. In this embodiment, the user interface includes a display 74 (e.g., a liquid crystal display), an alert indicator 76 in the form of a light emitting diode (LED), a low battery indicator 78 in the form of an LED, and an ON/OFF power switch 72. The user interface 70 may also include other inputs/outputs including, but not limited to, additional buttons, switches, or keypads, additional displays or indicators, audio outputs, and the like. Further, the user interface 70 may be positioned in a variety of locations on the lid 50.

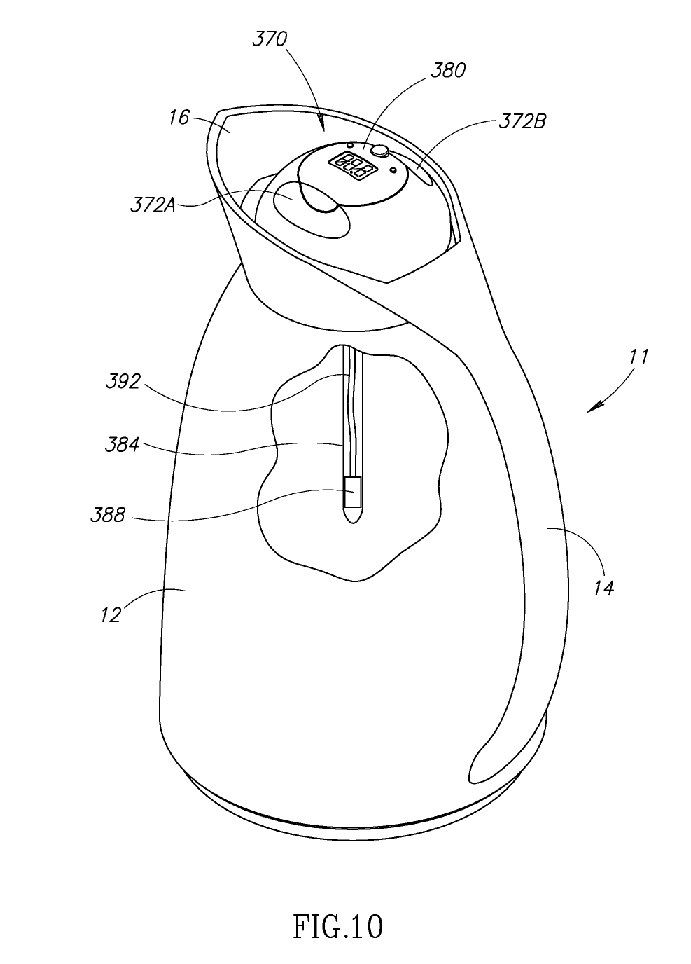

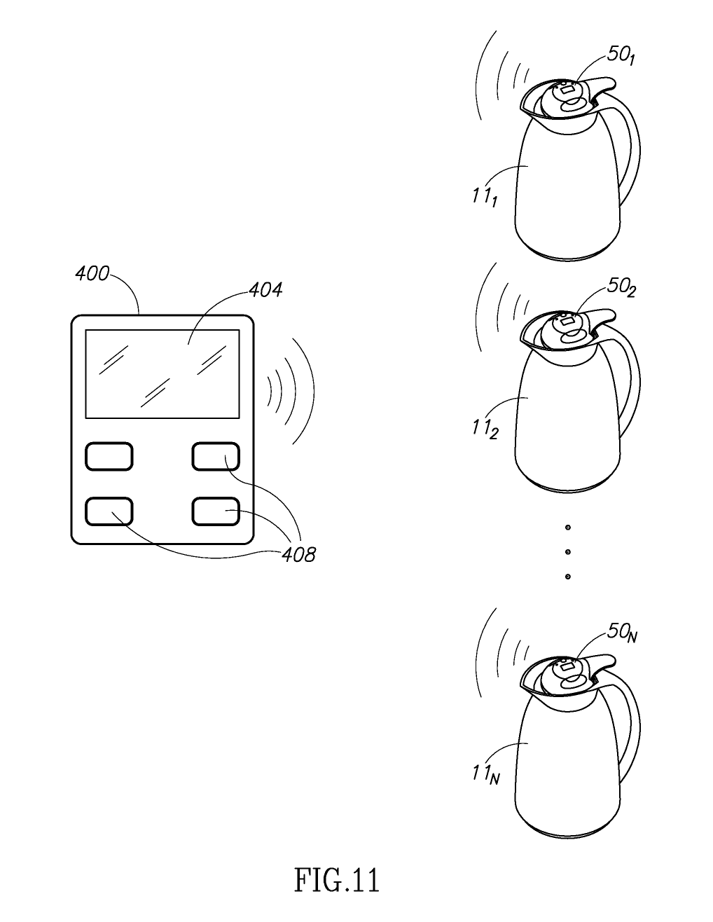

The electronics module 100 also includes a controller 60 that is operatively connected to the user interface 70 and the temperature probe 54. In some embodiments, the controller 60 may also be operatively connected to a wired or wireless communications interface 64 (see FIG. 11). In some embodiments, all or part of the controller 60 may be positioned at other locations, such as inside the temperature probe 54 (see FIG. 10). The controller 60 is operative to receive analog or digital signals from the temperature probe 54 that correspond to temperature measurements of a beverage stored in the beverage container 11. The controller 60 is also operative to control the operation of the display 74 and the indicators 76 and 78 by sending signals thereto. Further, the controller 60 is operative to receive signals from the ON/OFF switch 72 (or other available inputs) of the user interface 70. As can be appreciated, the controller 60 may include features of microcontrollers known in the art. For example, the controller 60 may include one or more processor cores, one or more types of memory, and input/output peripherals. The controller 60 may also comprise one or more discrete or integrated components. The controller 60 may be application specific or a generally available controller, provided that it is capable of performing the functionality discussed herein.

The electronics module 100 may include a selectively sealable compartment configured to store one or more rechargeable or non-rechargeable batteries operative to provide power to the electronic components described above. In addition to being replaceable and/or rechargeable, the batteries may be charged by a solar cell coupled to the lid 50. Further, the electronic components may be powered by a conventional AC power source using, for example, an AC/DC converter plug. In some embodiments, the electronic components may be powered by a long-life three (3) volt battery. In some embodiments, the controller 60 is also operative to monitor the status of the battery and to activate the low battery indicator 78 when the battery needs replacement. As an example, the low battery indicator 78 may blink or otherwise be activated when it is determined that the battery needs replacement. Further, for safety and clean-ability purposes, the lid 50 is configured so that the electronic components and battery are completely sealed from the exterior environment. Thus, the user may easily wash the lid 50 when desired.

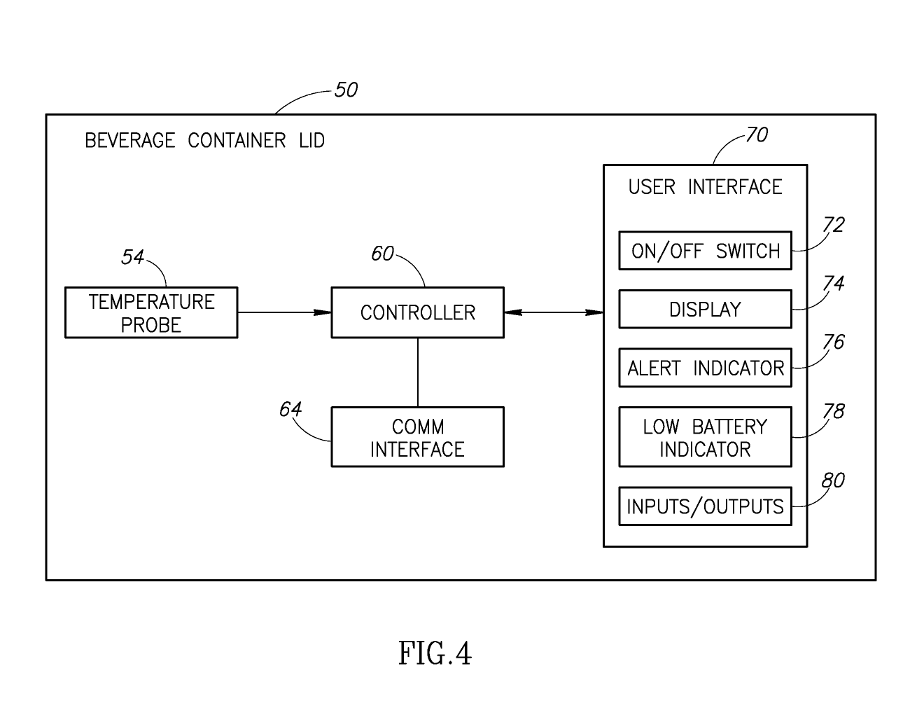

FIG. 5 illustrates a flow chart of a process 150 for monitoring the temperature of a beverage. As described below, the process 150 may be performed using the temperature monitoring beverage container and lid assembly 10 to signal to a user that a beverage is dangerously hot or undesirably cool. As an example, the process 150 may be operated when the beverage container 11 is used to store coffee or tea. The process 150 begins at block 154 when the temperature of a beverage stored in the beverage container 11 is monitored. As discussed above, the controller 60 is operative to receive analog or digital signals from the temperature probe 54 (or a temperature sensor disposed within the probe 54) indicative of the temperature of the beverage inside the beverage container 11. In some embodiments, the temperature probe 54 may output an analog voltage that is dependent on temperature. It will be appreciated that other methods may be used to sense the temperature of the beverage inside the beverage container 11.

At block 158, the controller 60 may display the current temperature of the beverage in the container 11 on the display 74. The temperature may be displayed in any suitable form (e.g., Fahrenheit, Celsius, or the like). By displaying the current temperature of the beverage, the user may quickly determine whether the beverage inside the container 11 is at a temperature suitable or desirable for consuming.

The process 150 continues at block 162, where the controller 60 determines whether the current temperature of the beverage is dangerously hot. This step may be performed by determining whether the current temperature is above a first predetermined or threshold temperature. The first predetermined temperature may be an empirically derived temperature known to be too hot for a user to drink. As an example, the first predetermined temperature may be 185 degrees Fahrenheit (F), 190 F, 195 F, or the like.

If the current temperature of the beverage is determined to be dangerously hot, the assembly 10 may provide an alert to a user, block 174. In the embodiment described above, the alert includes activating the alert indicator or LED 76 disposed on the electronics module 100 of the lid 50. As can be appreciated, other means for alerting the user, including audio and/or visual means, may be provided. For example, the lid may include a speaker for generating an audible alert to a user. In some embodiments, the lid 50 and/or container 11 may include means for vibrating (e.g., a vibrating battery, or the like), which functions to alert the user. The vibrating means may be triggered when an alert condition arises, or only when a user grasps or lifts the container 11 when an alert condition is present.

The process 150 also determines whether the current temperature of the beverage is undesirably cool, block 166. As discussed above, users may not wish to drink a hot beverage (e.g., coffee or tea) when it is below a certain temperature. This step may be performed by determining whether the current temperature is below a second predetermined or threshold temperature. As an example, the second predetermined temperature may be 120 degrees Fahrenheit (F), 115 F, 110 F, or the like. If the current temperature is determined to be undesirably cool, the alert may be provided. Further, if the temperature is determined to be neither too hot nor too cool (i.e., the temperature is between the first and second predetermined temperatures), the alert will be deactivated, block 170. In the embodiment described above, the alert is deactivated when the LED 76 is turned off.

It should be appreciated that other temperatures may be used for the first and second predetermined temperatures, depending on type of beverage, user preferences, and the like. Further, in some embodiments the first and second predetermined temperatures may be selectively modifiable by a user through the user interface 70.

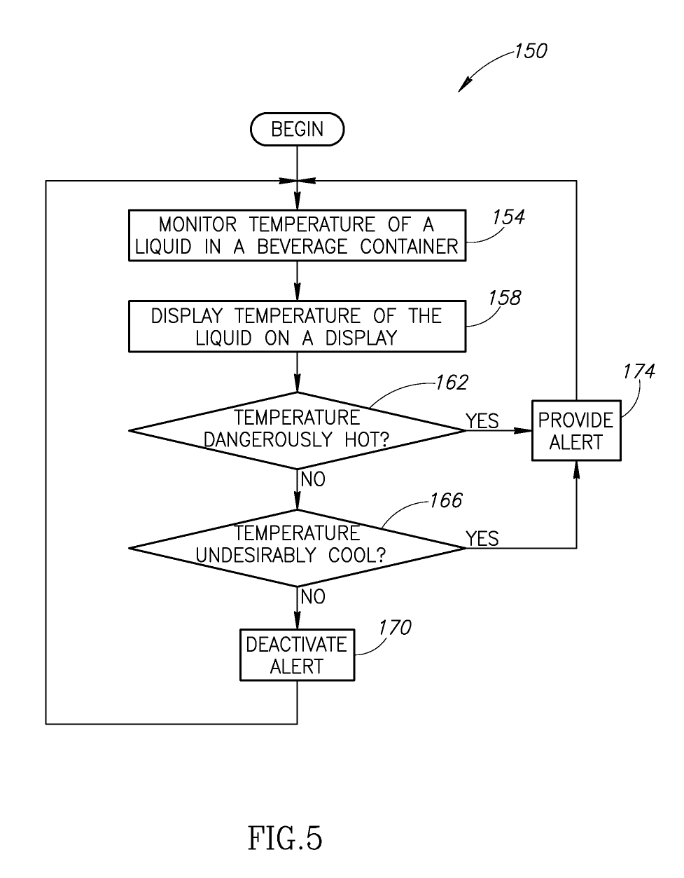

FIG. 6 illustrates a flow chart of another process 200 for monitoring the temperature of a beverage. The process 200 may be used for beverages that are served cold and are prone to spoilage when subjected to temperatures above a certain temperature. Examples of such beverages include milk and cream. Milk and cream may be susceptible to growth of bacteria and other germs when they are at temperatures above about 40 degrees Fahrenheit. As can be appreciated, consumption of spoiled beverages is undesirable because of changes in taste, the potential to cause illness, and the like.

Initially, like the process 150 of FIG. 5, the process 200 monitors the temperature of a beverage (e.g., milk) stored in a beverage container, block 204. The current temperature of the beverage may also be displayed on a display, block 208. The process 200 also includes determining whether the current temperature of the beverage is at a level where the beverage is prone to spoilage (“spoilage temperature”), block 212. For example, as described above, milk or cream may be prone to spoilage at temperatures above 40 degrees. The current measured temperature may be compared with the spoilage temperature (e.g., 40 degrees), and an alert may be provided to the user if the current temperature is at or above the spoilage temperature, block 216. If the current temperature is below the spoilage temperature, the alert may be deactivated, block 220. As discussed above, the alert indicator may comprise the LED 76 and/or other suitable audible or visual indicators, or vibrating indicators.

The process 200 of FIG. 6 may be useful in settings such as coffee shops where a carafe of milk is provided which allows users to add milk to their coffee or tea. In this case, an employee may fill the beverage container 11 (see FIG. 1) with cold milk, couple the lid 50 onto the beverage container, and activate the electronics module 100 by pressing the ON/OFF switch 72. The beverage container 11 may then be set out for customers of the coffee shop to use. As described above, the controller 60 will continuously monitor the temperature signals received from the temperature probe 54 and display the current temperature on the display 74. Further, if the temperature of the milk rises above the predetermined spoilage temperature, the alert LED 76 will be activated. In this regard, a user (e.g., a customer or employee of the coffee shop) will know that the milk in the beverage container should be replaced with fresh milk. Thus, customers are prevented from consuming spoiled milk that may have an undesirable taste or may cause illness due to the growth of bacteria or other germs. Further, the process 200 may be operative to alert users when the beverage container 11 is empty or near empty because, without a cold beverage in the container, the temperature therein will tend to rise quickly above the predetermined temperature and trigger the alert.

In some embodiments, the inputs 80 of the lid 50 (see FIG. 4) may include a switch for modifying the operation of the temperature monitoring beverage container and lid assembly 10. As an example, a user may be able to select whether alerts will be provided for a hot beverage (e.g., the process 150 of FIG. 5) or a cold beverage (e.g., the process 200 of FIG. 6). Additionally, the inputs 80 may allow a user to select one or more temperatures or temperature ranges used for activating the alerts. In this regard, a single beverage container may be easily customized by users for a variety of beverages and preferences.

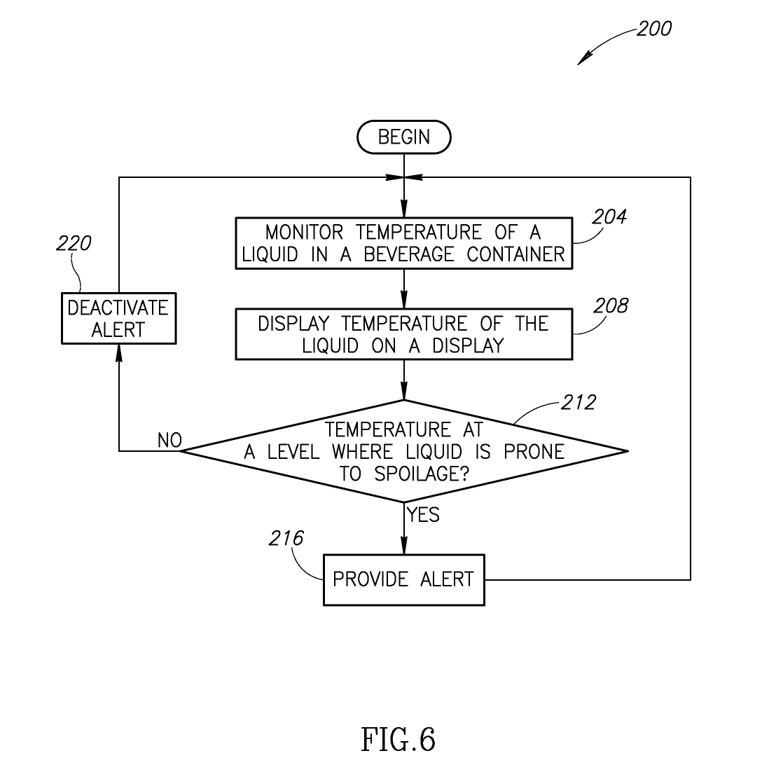

FIGS. 7-9 illustrate various other beverage containers in which the present invention may be utilized. It should be appreciated that these embodiments are provided as examples and are not exhaustive. FIG. 7 illustrates an airpot 250 that may be used to store and dispense coffee or tea. The airpot includes a main body or container 254, and a lid portion 256 comprising a spout 258 and a button 256. In operation, a user may depress the button 260 to cause a beverage stored in the container 254 to be dispensed through the spout 258.

The airpot 250 also includes a temperature monitoring system 270 that includes a display 274 and buttons/indicators 280. The temperature monitoring system 270 may include many or all of the same components as the embodiments described above. For example, the system 270 may include a controller and a temperature-sensing probe (not shown). Further, the system 270 may be operative to perform the same or similar functions as the embodiments described above (e.g., displaying current temperature, providing alerts, etc.).

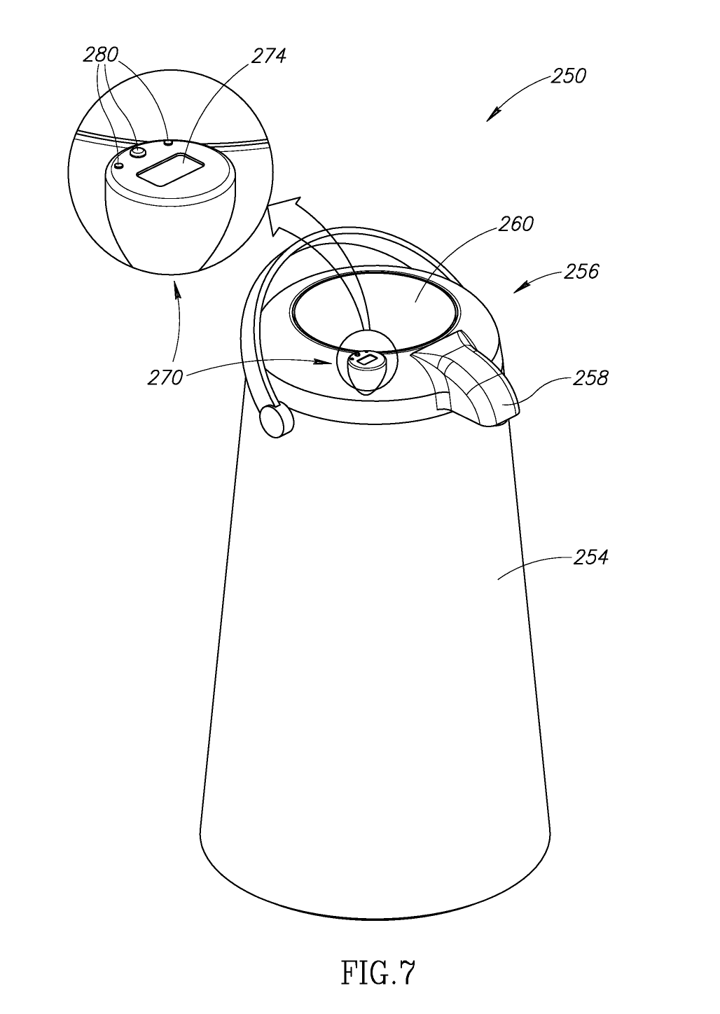

FIG. 8 illustrates a temperature monitoring system 304 that is integrated into an insulated beverage container 300 (e.g., an insulated beverage container such as a THERMOS, available from Thermos, LLC). The insulated beverage container 300 includes a main body or container 306 and a lid 308. The temperature monitoring system 304 may comprise a temperature sensor or probe that is disposed within the container 306 and operative to sense the temperature of a beverage inside the container of the insulated beverage container 300.

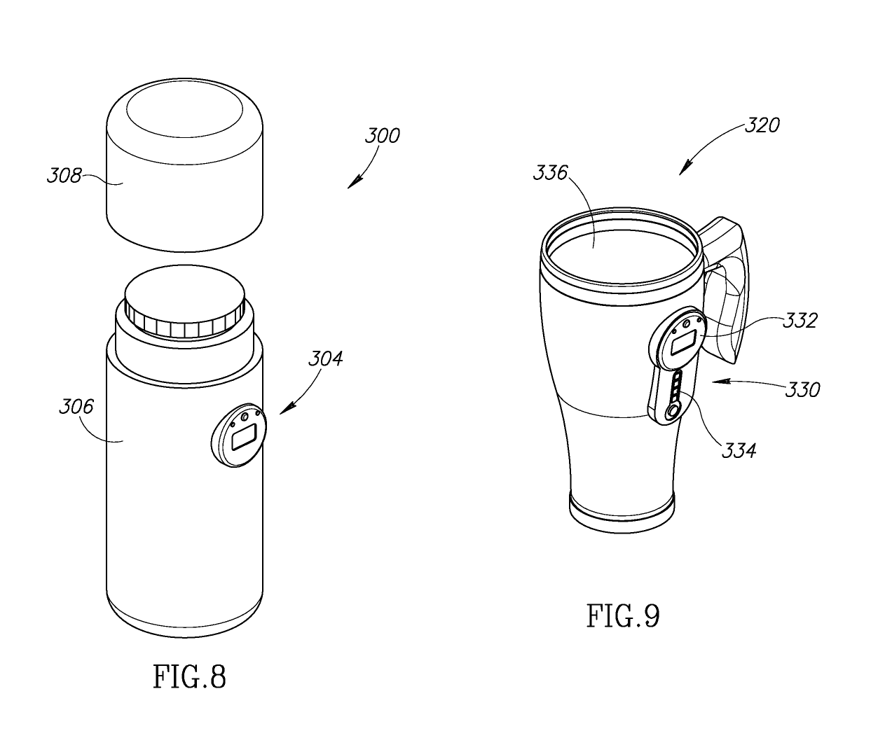

FIG. 9 illustrates a temperature monitoring system 330 that is integrated into a travel mug 320. The travel mug 320 includes a hollow interior region 336 in which a beverage may be contained. The temperature monitoring system 330 includes a user interface 332 that is similar to the user interface 70 described above. Further, the system 330 includes an indicator panel 334 in the form of a thermometer. The indicator panel 334 may comprise one or more lights (e.g., LEDs) that provide an indication of the current temperature of a beverage stored in the interior region 336 of the travel mug 320. As an example, when the temperature of the beverage is relatively hot, a row of lights extending the entire length of the thermometer 334 may be activated. Conversely, when the current temperature of a beverage is relatively cool, only the lights positioned near the bottom of the thermometer 334 may be activated. In addition, the lights of the thermometer 334 may be colored coded (e.g., red lights for “hot,” green lights for “cool,” etc.). As can be appreciated, the temperature sensing systems 304 and 330 of FIGS. 8 and 9, respectively, may include components and functionality similar to the embodiments described above.

FIG. 10 illustrates another embodiment of a lid 370 that may be used with the container 11 also shown in FIG. 1. The lid 370 includes an electronics module 380 and a temperature probe 384 that provide functionality as described above with reference to other embodiments. Rather than including an actuating member, the lid 370 may include an opening (not shown) that is selectively openable and closable by rotating a portion of the lid 370 relative to the container 11. To facilitate easy operation by a user, the lid 370 includes opposing grip surfaces 372A and 372B that allow the user to grasp the lid 370 to selectively open and close the opening so that the contents stored in the container 11 may be accessed. It should be appreciated that the present invention may also be implemented in lids or containers that open and close in other ways as well.

In the embodiment of FIG. 10, the temperature probe 384 includes a circuit board 388 disposed therein and located near the bottom of the probe. The circuit board 384 may include a power supply, low battery warning indicator circuitry, a controller (e.g., the controller 60), a temperature sensor circuit, and the like. The circuit board 388 may be operatively coupled to the electronics module 380 via a cable 392 disposed within the temperature probe 392. It should be appreciated that, like the lid 370, other embodiments discussed herein may also include a circuit board disposed within a temperature probe.

FIG. 11 illustrates a system for remotely monitoring beverages in a plurality of the beverage containers 11, labeled beverage containers 11_{1-N}. This embodiment utilizes the communications interface 64 (see FIG. 4) of the lid 50 to provide alerts to users remotely. The communications interface 64 may be any suitable wired or wireless communications interface. In the illustrated embodiment, the communications interface 64 is a wireless interface. The communications interface 64 may enable the controller 60 to communicate with a variety of input and output devices, including a status indication device or dashboard 400. Further, using the communications interface 64, the controller 60 may be operative to connect to or “pair” with one or several other devices or user interfaces simultaneously using any suitable communications technologies.

As shown in FIG. 11, the plurality of beverage containers 11_{1-N} and their corresponding lids 50_{1-N} may be operative to send temperature or alert information wirelessly to the dashboard 400. The dashboard 400 includes a communications interface that allows it to communicate with the communications interface 64 of each of the lids 50_{1-N}. The dashboard 400 includes a display 404 for presenting information relating to the beverage containers 11_{1-N}, and a plurality of input buttons 408. The dashboard 400 may also include other outputs such as LEDs, speakers, or the like, as well as other inputs such as keys, a touch screen, and the like. In general, the dashboard 400 is operative to receive temperature or alert signals from one or more beverage containers and, using the methods described herein, to provide appropriate alerts to a user.

The embodiment of FIG. 11 may be helpful in settings such as coffee shops, where one or more of the beverage containers 11_{1-N} may each be filled with a particular type of beverage (e.g., skim milk, half-and-half, soy milk, and the like). The beverage containers 11_{1-N} may be placed in an area convenient for customers to access. The dashboard 400 may be stored behind a counter where employees of the coffee shop work. In operation, the dashboard 400 may be operative to remotely receive signals from the lids 50_{1-N} of the beverage containers 11_{1-N} indicative of the alert conditions described above with reference to other embodiments. For example, if the temperature of milk in a particular beverage container 11₂ rises above a predetermined temperature threshold (e.g., 40 F), the communications interface 64 of the beverage container 11₂ may wirelessly send a signal to the dashboard 400 to alert an employee that the milk in the beverage container 11₂ needs to be replaced.

In some embodiments, the dashboard 400 is customizable so that it may indicate a particular type of beverage that needs replacement. For example, a coffee shop may designate the beverage container 11₁ for storing soy milk. Using the input buttons 408 or other means, this information may be input into a memory of the dashboard 400. In this example, when the dashboard 400 receives an alert for beverage container 11₁, the display 404 of the dashboard may be configured to display a message, such as “SOY MILK NEEDS REPLACEMENT,” so a user will easily know which beverage container needs attention. Advantageously, the features provided in this embodiment allow users to monitor the status of beverages in one or more beverage containers simultaneously without the need to be physically near the containers.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

What is claimed is:

1. A beverage container and lid assembly, comprising:
a beverage container having a cavity for receiving a beverage; and
a lid comprising:
a body selectively couplable to the beverage container, the body including a portion providing an opening configured to permit fluid passage therethrough when the lid is coupled to the beverage container;
a temperature sensor coupled to the body and downwardly extending therefrom into the cavity of the beverage container when the lid is coupled to the beverage container;
a display positioned on a surface of the body; and
a controller operatively coupled to the temperature sensor and the display, the controller being operative to receive signals from the sensor indicative of the temperature inside the cavity and to output temperature information on the display.

2. The beverage container and lid assembly of claim 1, further comprising an alert indicator, wherein the controller is operative to activate the alert indicator when the measured temperature is above a first predetermined temperature.

3. The beverage container and lid assembly of claim 2, wherein the alert indicator comprises a light emitting diode (LED).

4. The beverage container and lid assembly of claim 2, wherein the first predetermined temperature is between 38 and 42 degrees Fahrenheit.

5. The beverage container and lid assembly of claim 2, wherein the controller is further operative to activate the alert indicator when the measured temperature is below a second predetermined temperature.

6. The beverage container and lid assembly of claim 5, wherein the first predetermined temperature is at or above 185 degrees Fahrenheit and the second predetermined temperature is at or below 110 degrees Fahrenheit.

7. The beverage container and lid assembly of claim 1, wherein the beverage container comprises a carafe.

8. The beverage container and lid assembly of claim 1, wherein the beverage container comprises one of an insulated beverage container, a travel mug, and an airpot.

9. The beverage container and lid assembly of claim 1, further comprising an actuating member operative to selectively open and close the opening such that the cavity of the beverage container is sealed when the opening is closed.

10. The beverage container and lid assembly of claim 1, wherein the display comprises a liquid crystal display (LCD) screen.

11. The beverage container and lid assembly of claim 1, wherein the controller and the display are sealed in a water-resistant housing.

12. A beverage container lid, comprising:
a body selectively couplable to the beverage container, the body including a portion providing an opening configured to permit fluid passage therethrough when the lid is coupled to the beverage container;
a temperature sensor coupled to the body and downwardly extending therefrom into the cavity of the beverage container when the lid is coupled to the beverage container;
a display positioned on a surface of the body; and
a controller operatively coupled to the temperature sensor and the display, the controller being operative to receive signals from the sensor indicative of the temperature inside the cavity and to output temperature information on the display.

13. A method of preventing service of a spoiled beverage, the method comprising:
monitoring the temperature of a beverage disposed within a beverage container;
comparing the monitored temperature to a threshold temperature, wherein the beverage is known to be prone to spoilage at temperatures at or above the threshold temperature; and
providing an alert to a user when the monitored temperature is at or above the threshold temperature.

14. The method of claim 13, wherein providing an alert comprises activating a light emitting diode (LED) coupled to a portion of the beverage container.

15. The method of claim 13, wherein the threshold temperature is between 38 and 42 degrees Fahrenheit.

16. The method of claim 13, further comprising displaying the monitored temperature on a display that is coupled to the beverage container.

17. The method of claim 13, wherein the beverage container comprises one of a carafe, an insulated beverage container, a travel mug, and a beverage airpot.

18. A method of informing a user regarding the temperature of a beverage in a beverage container, the method comprising:
monitoring the temperature of the beverage disposed within the beverage container;
comparing the monitored temperature to a first threshold temperature, wherein the beverage is known to be undesirably hot at a temperature at or above the first threshold temperature;
comparing the monitored temperature to a second threshold temperature, wherein the beverage is known to be undesirably cool at a temperature at or below the second threshold temperature; and
providing an alert to a user when the monitored temperate is at or above the first threshold temperature or at or below the second threshold temperature.

19. The method of claim 18, wherein providing an alert comprises activating a light emitting diode (LED) coupled to the beverage container.

20. The method of claim 18, further comprising displaying the monitored temperature on a liquid crystal display (LCD) screen.
